(19) United States
(12) Patent Application Publication
(10) Pub. No.: US 2018/0282176 A1
(43) Pub. Date: Oct. 4, 2018

(54) METHOD FOR REDUCING HEXAVALENT CHROMIUM IN OXIDIC SOLIDS

(71) Applicant: LANXESS Deutschland GmbH, Cologne (DE)

(72) Inventors: Rainer ORTMANN, Cologne (DE); Holger FRIEDRICH, Krefeld (DE); Matthias BOLL, Newcastle (ZA)

(73) Assignee: LANXESS Deutschland GmbH, Cologne (DE)

(21) Appl. No.: 15/524,426

(22) PCT Filed: Oct. 14, 2015
(86) PCT No.: PCT/EP2015/073770

§ 371 Date: May 4, 2017

(30) Foreign Application Priority Data
Nov. 13, 2014 (EP) 14193035.4

(51) Int. Cl. C01G 49/00; C22B 34/32

(52) U.S. Cl. CPC C01G 49/0045; C22B 34/32

(57) ABSTRACT

Process for reducing hexavalent chromium in oxidic solids, which comprises the steps:
a) heating of the oxidic solid containing Cr(VI) to a temperature of from 600 to 1400° C. in an atmosphere containing less than 0.1% by volume of an oxidizing gas and
b) cooling of the reaction product obtained after step a) to a temperature below 100° C. in an atmosphere containing less than 0.1% by volume of an oxidizing gas,
   characterized in that no reducing agent is added to the oxidic solid or to the atmosphere in step a) and b) in the process.

The invention relates to a process for reducing hexavalent chromium Cr(VI) in oxidic solids. In particular, it concerns the reduction of Cr(VI) in chrome ore residues (in English also referred to as Chromite Ore Processing Residue (COPR)) which are obtained as by-products in the production of chromium chemicals from chromite (chrome iron ore).

Among the various minerals containing chromium, only the chromium spinels, especially chromite (chrome iron ore, idealized: FeCr₂O₄), are of economic importance.

Sodium dichromate is by far the most important starting material for producing chromium chemicals, The only process for producing sodium dichromate from chromite which is carried out industrially on a large scale is the oxidative alkaline digestion of chromite using sodium carbonate (soda) or sodium hydroxide and air or oxygen in the presence of an opening material at temperatures of about 1100° C. This process, which has been described comprehensively in the specialist literature, will be discussed only briefly here (see, for example, Ullmann's Encyclopedia of Industrial Chemistry, online Edition, Vol. A9, pages 163-166, Wiley-VCH Verlag GmbH Co. KGaA, Weinheim 2012, published online 15 Jun. 2000). it comprises essentially three steps:

oxidative digestion of chrome ore or chrome ore concentrate under alkaline conditions

leaching out of the sodium monochromate formed and separation of the sodium monochromate containing solution from the insoluble residue (chrome ore residue) by solid-liquid separation

conversion of the sodium monochromate into sodium dichromate by acidification of the solution,

Apart from chromite and sodium alkalis, especially sodium carbonate, materials which are intended to maintain the porosity of the furnace contents during digestion (known as opening materials) are additionally added to the furnace mixture, The porosity is necessary to provide a sufficient surface area for the reaction with oxygen. The chromium yield when chromite is used is, depending on the composition, in the range from 74% to 90% of the chromium present in the chrome ore.

In the process for producing sodium dichromate, part of the sodium carbonate which is necessary for the alkaline digestion can be replaced by calcium carbonate CaCO₃ or dolomite (CaMg(CO₃)₂) or calcium oxide CaO (lime). Such processes are, depending on the proportion of added calcium oxide, referred to as high lime, no lime or low lime processes. The disadvantages of the use of calcium oxide are that up to four tonnes of toxic hazardous waste, which is carcinogenic because of its calcium chromate content, are formed per tonne of sodium dichromate produced. It is therefore desirable to add as little calcium oxide as possible to the alkaline digestion.

The dissolved monochromate is separated off after cooling and leaching at a pH set by addition of acids or dichromate solution by means of solid-liquid separation, generally by filtration, The insoluble residue is leached a number of times in order to reduce the content of water-soluble Cr(VI). Part of the residue can be dried in order to be fed back to the furnace mixture as opening material.

The remaining residue, known as chrome ore residue (Chromite Ore Processing Residue, C (PR), still contains Cr(VI). Part of the Cr(VI) is still in water-soluble form as sodium monochromate, but leaching at low Cr(VI) contents is no longer economically feasible. In addition, part of the Cr(VI) is also in water-insoluble or sparingly water-soluble form which can likewise not be recovered with an economically justifiable outlay.

The chrome ore residue can, depending on whether the high lime process, no lime process or low lime process has been used for the oxidative alkaline digestion of chrome ore, fluctuate in terms of its composition, in particular the CaO content. Chrome ore residues from the high lime process comprise up to 35% by weight of CaO, those from the no lime process usually comprise less than 5% by weight, while those from the low lime process contain from 5 to 35% by weight.

When the chrome ore residue is disposed of in a landfill in its leached form and without additional appropriate treatment, as was often the case in the past, the sparingly soluble Cr(VI) compounds can still slowly be leached out over decades and Cr(VI) can thus get into the environment. For this reason, the groundwater and the earth around many chrome ore residue landfills are polluted with a high level of Cr(VI).

For this reason, the chrome ore residue has for some decades generally been subjected to a reduction process in order to convert the Cr(VI) still present into unproblematical Cr(III) before it is finally disposed of in a landfill. It is important here that very complete reduction of the Cr(VI) present is achieved, with the difficult-to-access and water-insoluble or sparingly water-soluble Cr(VI) which is not located at the surface of the residue but is instead enclosed by a silicon dioxide and/or aluminium oxide layer also being included.

In addition, treatment with a chemical reducing agent such as Fe(II) sulphate or sulphur dioxide is known, with the latter also being able to be used in the form of hydrogen sulphite ions (see Ullmann's Encyclopedia of Industrial Chemistry, online Edition, Vol. A9, page 165, Wiley-VCH Verlag GmbH Co. KGaA, Weinheim 2012, published online 15 Jun. 2000).

Recently, the use of other reducing agents or mixtures of various reducing agents has also been proposed for the treatment of chrome ore residues. Thus, Su and Ludwig (Environ Sci. Technol. 2005, 39, 6208-6216) propose, for example, a mixture of Fe(II) sulphate and sodium dithionite (Na₂S₂O₄). The advantage of this FeSO₄/Na₂S₂O₄ mixture is that the precipitation of Fe(II) ions is prevented by Na₂S₂O₄ and a more effective reduction of Cr(VI) is thus said to he ensured over a relatively long period of time. Nevertheless, complete reduction of the Cr(VI) in the chrome ore residue was not able to be effected in this process. In the alkaline digestion, process described in USEPA (United States Environmental Protection Agency, USEPA) SW-846 Method 3060A, the Cr(VI) content decreases merely from 252 mg/kg to 31.4 mg/kg.

The use of calcium polysulphide (CaS₅) or mixtures of Fe(II) sulphate and calcium polysulphide for reducing the Cr(VI) content in chrome ore residues has also been reported in the literature. Thus, for example, Graham et al. (Science of the Total Environment, 2006, 364(1-3), 32-44), Moon et al. (Science of the Total Environment, 2008, 399, 2-10) and Wazne et al. (Geosciences Journal, 2007, 11(2), 105-110) describe experiments in which calcium polysulphide was used as reducing agent. However, in all cases complete reduction of the Cr(VI) in the chrome ore residue could not be successfully achieved.

All these processes are based on a reducing agent which is stable over a very long period of time and is thus also able to reduce the Cr(VI) which is liberated only slowly from the chrome ore residue over a very long period of time being provided for the reduction of Cr(VI). However, since the liberation of Cr(VI) can continue for decades, it is doubtful that these proposals are actually suitable for reducing Cr(VI) in the chrome ore residue completely. Thus, for example, Fe(II) is, even at very low pH values, slowly oxidized in air to Fe(III) and is then no longer available as reducing agent.

US 2010/0135876 A1 discloses a wet-chemical process for reducing Cr(VI) in chrome ore residues, in which Fe(II) ions which act as reducing agent are “fixed” in the form of a sparingly soluble precipitate on the surface of the COPR particles and are thus also supposed to be able to be effective over a relatively long period of time. In the process disclosed, the Cr(VI) present in the COPR matrix is firstly dissolved by adding a sufficient amount of Fe(II) sulphate. The Fe(II) ions also effect reduction of the liberated Cr(VI) to Cr(III). At the same time, Fe(OH)₃ and Al(OH)₃ and also CaSO₄ precipitate, which promotes the dissolution of the COPR particles. Excess Fe(II) is then “fixed” in the form of a sparingly soluble precipitate on the surface of the COPR particles. This is preferably effected by addition of a sulphide, for example sodium sulphide (Na₂S), sodium hydrogensulphide (NaHS) or calcium polysulphide (CaS₅), as a result of which iron(II) sulphides are precipitated, or by addition of phosphoric acid, as a result of which Fe(II) phosphates are precipitated. However, it is known that FeS decomposes in boiling water. Under the conditions of the alkaline digestion process as per USEPA SW-846 Method 3060A, FeS decomposes again. The Fe(II) and sulphide ions liberated here can then reduce the Cr(VI) still bound in the COPR matrix, which is likewise liberated during the alkaline digestion process, resulting in a falsified result since Cr(VI) can no longer be detected.

In addition. US 2010/0135876 A1 describes the phenomenon that, after drying of the COPR samples which have been reduced only with Fe(II) sulphate, significant amounts of Cr(VI) (about 1100 ppm or 1500 ppm) can be detected again by means of the alkaline digestion process. They attribute this either to a reoxidation of Cr(III) to Cr(VI) by means of atmospheric oxygen or oxidation of Fe(II) to Fe (III) by means of atmospheric oxygen. However, US 2010/0135876 A1 does not take into account that the dissolution of the Cr(VI) bound in the COPR matrix is incomplete.

Cao and Zhang (J. Hazard. Materials B, 2006, B132, 213-219) describe the use of nanosize iron particles (known as zero-valent iron) as reducing agent. A disadvantage of this process is that the nanosize iron particles (<100 nm, specific surface area about 35 m²/g) are very costly to produce and are therefore suitable at most for laboratory experiments, but at present do not come into question for use on an industrial scale. In addition, the nanosize iron particles are slowly oxidized by air and/or moisture, so that it can be doubted that this material is able to reduce hexavalent chromium in chrome ore residues over a number of years.

In the meantime, efforts have also been made to reduce Cr(VI) by a biological route. Reference may here he made to Zhu et al, (World J Microbiol Biotechnol, 2008, 24, 99l.996) by way of example. They describe the use of Leucobacter sp, CR1B bacteria which were able to be isolated from a chrome ore residue landfill in Changsha (People's Republic of China). The bacteria are able to reduce dissolved Cr(VI), with the reduction occurring most readily at a neutral pH. Production and use of bacteria for reduction of Cr(VI) on a large scale conceals the disadvantage that no findings whatsoever on the long-term effects of these bacteria in the ecosystem are available at present. Long-term studies on this subject are still required in order to he able to estimate whether this route represents a practicable alternative to the chemical reduction of Cr(VI) in chrome ore residues.

Thermal reduction processes for chrome ore residues have also been known for a long time. Thus, for example, some Japanese patents describe the use of reduced chrome ere residues as black and brown pigments in the production of ceramics (JP62 036061A and JP58-225158A) and roofing tiles (JP59-92968A, JP62 036061A), with a large amount of coke also sometimes being additionally added as reducing agent to the ceramic composition. According to data from the inventors. the following reactions in which Cr(VI) is converted into Cr(III) proceed during firing.

2CaO*CrO₃+2SiO₂→2CaO*SiO₂+Cr₂O₃+3/2O₂ (1)

2Na₂O*CrO₃+2SiO₂→2 Na₂O*SiO₂+Cr₂O₃+3/2 O₂ (2)

In the chocolate-coloured ceramics obtained after firing at at least 1200°C., Cr(VI) is obviously no longer detectable, but the analytical method employed and the atmosphere under which the ceramic bodies are fired are not disclosed. However, it has to be assumed that firing was carried out under reducing conditions because reoxidation of Cr(III) to sodium chromate always occurs at such a high temperature in the presence of oxygen and alkali metal ions.

Wang et al. (Journal of Hazardous Materials, 2007, 149, 440-444) describe the reduction of the Cr(VI) present in the chrome ore residue by means of sucrose, soluble starch or flour by reaction under inert gas at elevated temperatures. Here they report obtaining complete conversion of Cr(VI) into Cr(III) at temperatures up to 600°C. The chrome ore residue, which contains about 34% of CaO, is pulverized in a mortar and then mixed with the appropriate reducing agents in the laboratory experiments described. In order to ensure complete and uniform contact between the chrome ore residue particles and the reducing agent, these are added in an aqueous solution or suspension. The reduction is carried out in a tube furnace under a carbon dioxide atmosphere. Systematic variation of the reaction time, reaction temperature and the amount of reducing agent added was carried out. It is found here that, at a reaction temperature of 600° C., a mass ratio of 2.0:1 (reducing agent: Cr(VI)) is necessary in order to obtain complete reduction at a reaction time of 20 minutes. On the basis of the two reaction equations below, for the example of sucrose, it is found that 16 mol of Cr(VI)) can be reduced by 1 mol of sucrose, i.e. at least 0.41 g of sucrose are theoretically required for reducing 1 g of Cr(VI):

16CaCrO₄+C₁₂H₂₂O₁₁+4 CO₂→8 Cr₂O₃+16CaCO₃+11H₂O (3)

16Na₂CrO₄+C₁₂H₂₂O₁₁4+CO₂→8Cr₂O₃+16Na₂CO₃+11 H₂O (4)

However, in order to obtain complete reduction, at least a mass ratio of 20:1, i.e. 2.0 g of sucrose for 1 g of Cr(VI), has to be selected instead of the theoretical mass ratio of 0.41:1. Wang et al, indicate the proportion of water-soluble Cr(VI) in the chrome ore residue used by them to be 1.07%. At a mass ratio of 2.0:1 (reducing agent:Cr(VI), this means that at least 2.14% by weight of reducing agent have to be added in order to obtain complete reduction, according to the analytical result.

The process for reducing Cr(VI) described by Wang et al. has a number of disadvantages. The reaction products obtained were leached out in accordance with the Chinese standard GR5086.2-1997 and analysed for Cr(VI) in accordance with GB/T15555.4-1995. GB5086.2-1997 merely describes an extraction with water at room temperature. Thus, only the water-soluble Cr(VI) is measured, while the sparingly soluble or insoluble Cr(VI)-containing compounds are not measured using this extraction process. This means that the results presented by Wang do not allow a statement to be made regarding the actual success of its 1.0 reduction of Cr(VI) to Cr(III), James et al. (Environ. Sci. Technol. 1995, 29, 2377-2381) have examined and compared the extraction of Cr(VI) using various methods. It is clear from this that the digestion of Cr(VI) with a sodium carbonate/sodium hydroxide mixture (0.28 M Na₂CO₃ and 0.5 M NaOH) at 90-95° C. over a period of 60 minutes is the most effective method of measuring all types of Cr(VI), regardless of whether they are water-soluble or sparingly soluble. The latter digestion method, as described in USEPA (United States Environmental Protection Agency, USEPA) SW-846 Method 3060A is according to present-day knowledge the most sensitive extraction process for Cr(VI) in waste and is therefore also becoming increasingly established as standard analytical method for the release of Cr(VI) from chrome ore residues.

As our own studies show, the reaction products described by Wang et al, are not free of Cr(VI) even at a reaction temperature of 600° C. and a mass ratio of 2.0:1 (reducing agent:Cr(VD) and a reaction time of 20 minutes when they are digested and analysed in accordance with USEPA SW-846 Method 3060A. Complete reduction is thus only falsified, because an unsatisfactory analytical method is employed. It should also be mentioned that an extremely unpleasant odour occurs in the pyrolysis of flour, starch or sucrose, and this is an additional disadvantage of this method of reduction,

Zhang et al. (Chemosphere, 2009, 77(8), 1143-45) describe the reduction of Cr(VI) in the chrome ore residue by pyrolysis using rice straw. In this publication, the reaction products were extracted in accordance with USEPA SW-846 Method 3060A. The chrome ore residue used for the experiments contained 3400 ppm of Cr(VI). The rice straw:chrome ore residue ratio was varied in the range from 1:10 to 1:2 and the reaction temperature was increased up to 600° C. Under none of the reaction conditions described could a Cr(VI) J-free end product be obtained, It always contained at least about 30 ppm of Cr(VI). Presumably, although the water-soluble Cr(VI) constituents are reduced by the pyrolysis using rice straw, the sparingly soluble or insoluble Cr(VI) constituents remain, at least in part, as hexavalent chromium. In addition, sulphur compounds are brought into the process by the straw. Under the reducing conditions during the reaction, sulphides are formed and remain in the end product. When the reduced chrome ore residue is suspended in a weak acid, a very unpleasant odour of hydrogen sulphide (H₂S) arises.

Zhang et al. (Bioresource Technology, 2009, 100(11), 2874-2877) also describe the reduction of the Cr(VI) present in the chrome ore residue by pyrolysis using sewage sludges. Here, the sewage sludge is mixed in a ratio of 1:10 with chrome ore residue and subsequently subjected to a pyrolysis at 600° C. The release of the Cr(VI) is likewise carried out by the alkaline digestion process described in USEPA SW-846 Method 3060A. In this process, too, the Cr(VI) content of originally 3384 ppm in the untreated chrome ore residue can be decreased to only 24 ppm. The pyrolysis of chrome ore residue using sewage sludges, as described by Zhang, is accordingly nota suitable process for obtaining Cr(VD-free chrome ore residue. Furthermore, sulphur compounds are also introduced into the process here via the sewage sludges, and these can, as described above, cause the unpleasant odour of hydrogen sulphide (H₂S) to arise.

US 2004/0086438 A1 discloses a process by means of which the chromium present in the chrome ore residue and the iron can be recovered at the same time. Here, the chrome ore residue is firstly treated with at least 20% by weight of a metal hydroxide, preferably sodium or potassium or lithium hydroxide, at at least 350° C. for at least 10 minutes in air. This is followed by an acidic work-up which leads to an iron-rich insoluble residue. Further disadvantages are the molten metal hydroxides required, which are very corrosive and extremely difficult to handle. Implementation of this process on an industrial scale is therefore associated with considerable problems. Accordingly, only 1 g of chrome ore residue is reacted in small laboratory experiments in virtually all examples disclosed, Only in one example, a 100 g batch in a rotary tube furnace is described, but it is not indicated how this is operated. A further serious disadvantage of the process is that large amounts of hydroxides and acids are added, so that large amounts of dissolved salts are obtained. The salt content in the process water is therefore very high. In addition, a large amount of calcium oxide is advised for the process, since the calcium is required for precipitation of sulphate as calcium sulphate. The disadvantages of the addition of calcium oxide have already been mentioned.

It was an object of the present invention to provide an economically usable process in which the hexavalent chromium present in an oxidic solid is reduced to such an extent that a Cr(VI) content of <1000 ppm, preferably less than 100 ppm, can be detected in the resulting end product according to a modified alkaline digestion process which is disclosed in the present patent application and is based on USEPA SW-846 Method 3060A. In the process for reducing the hexavalent chromium, the disadvantages resulting from the use of the reducing agents of the prior art, for example the need for exhaust air treatment, problematical metering of the reducing agent and increased costs, should preferably be overcome.

According to the REACH regulation, chromium(VI) compounds are materials of particular concern and are on the SVHC (Substances Of Very High Concern) list. Product mixtures having a proportion of greater than or equal to 1000 ppm of chromium(VI) therefore have to be designated accordingly (1272/208/EC and 1999/45/EC regulations).

It has surprisingly been found that the reduction of Cr(VI) in oxidic solids can be achieved very successfully by the modified alkaline digestion process which is disclosed in the present patent application and is based on USEPA SW-846 Method 3060A, even when no reducing agent is added to the oxidic solid or to the atmosphere containing less than 0.1% by volume of an oxidizing gas.

The invention therefore provides a process for reducing hexavalent chromium in oxidic solids, which comprises the steps;
heating of the oxidic solid containing Cr(VI) to a temperature of from 600 to 1400° C. in an atmosphere containing less than 0.1% by volume of an oxidizing gas and
b) cooling of the reaction product obtained after step a) to a temperature below 100° C. in an atmosphere containing less than 0.1% by volume of an oxidizing gas,
   characterized in that no reducing agent is added to the oxidic solid or to the atmosphere in step a) and b) in the process.

For the purpose of the present invention, the term reducing agent refers to at least one compound which reduces Cr(VI) to Cr(III) at least under the reaction conditions prevailing in step a) and h).

For the purposes of the present invention, the expression “no reducing agent is added” means that no reducing agent is added to the oxidic solid or to the atmosphere containing less than 0.1% by volume of an oxidizing gas. Particular preference is given to not adding any reducing agent during the entire process of the invention.

The useful aspect of the process of the invention is, inter alia, that the reduced oxidic solid obtained, in particular the reduced chrome ore residue, no longer has to be regarded as hazardous material and disposed of in a landfill, but can be introduced as material of value into a new value added chain.

The fact that a reducing agent is not added in the process of the invention results in numerous advantages compared to the reduction processes of the prior art: firstly, there is a considerable cost advantage since costs of reducing agent are not incurred. Furthermore, the procedure is significantly simplified technically by metering of the reducing agent not having to he carried out and by the use of a mixer which mixes the oxidic solid and the reducing agent being dispensed with. Furthermore, the offgas treatment is significantly simplified since the offgas no longer contains any residues of organic or inorganic decomposition products of the reducing agent which require treatment.

Step a)

It is in principle possible to use all types of oxidic solids containing hexavalent chromium for the process of the invention.

Preference is given to using chrome ore residues which are obtained in the oxidative alkaline digestion of chrome ores, for example chromite, for the production of sodium monochromate.

The process of the invention is particularly preferably carried out using a chrome ore residue which is obtained in the process for producing sodium monochromate from chromite via an oxidative alkaline digestion with sodium carbonate (no lime process, CaO content of <5% by weight),

Preference is also given to using other Cr(VI)-containing residues as are obtained, for example, from the work-up and reprocessing of sodium monochromate, with calcium vanadate formed in the separation of vanadium from the monochronate solution particularly preferably being used as other Cr(VI)-containing residue. It is also possible to use mixtures of oxidic solids. Such a mixture preferably contains chrome ore residues and other Cr(VI)-containing residues as are obtained, for example, from the work-up and reprocessing of sodium monochromate, with calcium vanadate formed in the separation of vanadium from the monochromate solution particularly preferably being used as other Cr(VI)-containing residue.

The oxidic solids can contain further metal oxides such as chromium(III) oxide (Cr₂O₃), aluminium oxide (Al₂O₃), iron(III) oxide (Fe₂O₃), magnesium oxide (MgO), calcium oxide (CaO), silicon oxide (SiO₂), vanadium oxide (V₂O₅), sodium oxide (Na₂O) and sodium monochromate (Na₂CrO₄).

The oxidic solids preferably have a Cr(VI) content of up to 80 000 ppm, particularly preferably up to 50 000 ppm, very particularly preferably from 1000 to 15 000 ppm, determined by the modified alkaline digestion process based on USEPA SW-846 Method 3060A.

The Cr(VI) is preferably present as sodium monochromate (Na₂CrO₄) in the oxidic solids.

The oxidic solids can be fed as water-containing filter cake to step a). However, they are used in dried form in a preferred embodiment of the process of the invention. They particularly preferably have a moisture content of not more than 2.0% by weight, very particularly preferably less than 1,0% by weight.

The CaO content of the oxidic solid is preferably less than 15% by weight, very particularly preferably less than 10% by weight, in particular less than 5% by weight.

The chrome ore residues are usually obtained as moist filter cakes after solid-liquid separation in the process for producing sodium monochromate and can be fed in this form to step a). Other Cr(VI)-containing residues are preferably used with a vanadium content of from 12 to 15% by weight. Mixtures of chrome ore residue and vanadate-containing other residue preferably contain up to 15 000 ppm of Cr(VI). Mixtures of oxidic solids preferably contain at least 85% by weight of chrome ore residues, particularly preferably at least 90% by weight of chrome ore residues,

The oxidic solids particularly preferably have the following composition:

chromium(III) oxide (Cr₂O₃): from 7 to 13% by weight, preferably from 7.5 to 12.5% by weight

aluminium oxide (Al₂O₃): from 10 to 30% by weight, preferably from 18 to 24% by weight

iron(III) oxide (Fe₂O₃): from 42 to 50% by weight, preferably from 42 to 48% by weight

magnesium oxide (MgO): from 9 to 18% by weight, preferably from 10 to 17% by weight

calcium oxide (CaO): <10% by weight, preferably <5% by weight

silicon oxide (SiO₂): from 0 to 3% by weight, preferably from 1 to 3% by weight.

vanadium oxide (V₂O₅): <1% by weight, preferably <0.5% by weight

sodium oxide (Na₂O): from 0 to 5% by weight, preferably from 2 to 5% by weight

sodium monochromate (Na₂CrO₄): from 0.3 to 4.7% by weight

Oxidic solids in which at least 90% of the particles are smaller than 500 μm, very particularly preferably smaller than 300 μm, are preferably used for the process of the invention. Such particle sizes can, if necessary, be achieved by sieving and/or milling before step a).

The atmosphere in step a) contains less than 0.1% by volume of an oxidizing gas, with the oxidizing gas preferably being oxygen.

The atmosphere in step a) preferably contains less than 0.01% by volume of an oxidizing gas,

The atmosphere in step a) containing less than 0.1% by volume, preferably less than 0.01% by volume, of an oxidizing gas is particularly preferably selected from the group consisting of an inert gas atmosphere and vacuum.

In a preferred embodiment, the atmosphere in step a) containing less than 0.1% by volume, particularly preferably less than 0.01% by volume, of an oxidizing gas is an inert gas atmosphere.

The inert gas atmosphere preferably comprises at least 90% by volume, preferably at least 95% by volume, very particularly preferably at least 99% by volume, very very particularly preferably at least 99.5% by volume, of one or more gases selected from the group consisting of noble gases, in particular from helium and argon, nitrogen and carbon dioxide, preferably selected from the group consisting of nitrogen and carbon dioxide, very particularly preferably nitrogen.

The inert gas is preferably passed over the oxidic solid, particularly preferably by means of an inert gas stream, very particularly preferably by means of an inert gas stream of about one third of the reactor volume/min, very very particularly preferably by means of an inert gas stream of about one third of the reactor volume/min at atmospheric pressure in the reactor (about 1013 mbar).

In another preferred embodiment, the atmosphere in step a) containing less than 0,1% by volume, particularly preferably less than 0.01% by volume, of an oxidizing gas is vacuum.

For the purposes of the present invention, the term vacuum preferably refers to an atmosphere haying a pressure of less than 800 mbar, particularly preferably less than 650 mbar, very particularly preferably less than 450 mbar.

In step a), the oxidic solid is heated to a temperature of from 600° C. to 1400° C., preferably to a temperature of from 850° C. to 1200° C., very particularly preferably to a temperature of from 950° C. to 1150° C. The reaction time depends on the temperature used and can be determined simply in a manner which is adequately known to a person skilled in the art. The reaction time is preferably from five minutes to 24 hours, preferably from 1

to 10 hours.

The heating in step a) is preferably carried out in a reactor. Possible reactors are all apparatuses which can ensure the temperatures required in step a) and the atmosphere containing less than 0.1% by volume of an oxidizing gas required in step a).

The heating in step a) can be carried out in a continuously operating or discontinuously operating reactor. The heating in step a) is preferably carried out in a continuously operating reactor.

The reactor can be indirectly or directly heated, with preference being given to using an indirectly heated reactor in step a). Step a) is particularly preferably carried out using a reactor which is indirectly heated by means of gas or electricity, very particularly preferably an indirectly electrically heated reactor.

In addition, the use of indirectly heated reactors has the advantage that only a very small gas flow prevails in the reaction space itself, as a result of which virtually no dust is discharged.

As reactors in step a), it is possible to use, for example, furnaces of a wide variety of types. Customary furnaces such as tray furnaces, muffle furnaces, tube furnaces, convection furnaces and retort furnaces are known to those skilled in the art. The furnace used in step a) is preferably a tube furnace, particularly preferably a horizontal tube furnace, very particularly preferably a two-zone rotary tube furnace.

In step a), the oxidic solid can be present in any vessel which is inert to the reaction conditions prevailing in step a), The oxidic solid is preferably present in a crucible, particularly preferably in a silicon carbide crucible, during heating.

Step b)

In step b), the reaction product obtained after step a) is cooled to a temperature below 100° C. in an atmosphere containing less than 0.1% by volume of an oxidizing gas.

The cooling in step b) is preferably carried out in a reactor. Possible reactors are all apparatuses which can ensure the temperatures required in step b) and the atmosphere containing less than 0.1% by volume of an oxidizing gas required in step b).

The preferred ranges for the atmosphere containing less than 0.1% by volume of an oxidizing gas as have been indicated under step a) and for the reactors indicated under step a) apply analogously to step b).

The reaction product obtained after step a) is preferably cooled to a temperature below 40° C., particularly preferably below 30° C. in step b). In this way, reoxidation Cr(III) to Cr(VI) can be effectively avoided, as studies have shown.

The cooling of the reaction product obtained after step a) can be carried out in step b) by the reaction product obtained after step a) remaining in the reactor and the reactor being cooled by means of inert gas after the indirect heating has been switched off.

The cooling of the reaction product obtained after step a) can also be carried out in step b) in such a way that the reaction product obtained after step a) remains in the reactor and is cooled under vacuum.

The cooling of the reaction product obtained after step a) in step b) can also be carried out in a continuously operating or discontinuously operating cooling apparatus, preferably in a continuously operating cooling apparatus. As examples of continuously operating cooling apparatuses, mention may here merely be made of fixed-bed heat exchangers, screw heat exchangers (cooling screws) or cooling drums.

The use of a rotary tube furnace having two temperature zones is also conceivable for combined use in step a) and b). The cooling of the reaction product obtained after step a) in step b) can consequently also be carried out in a two-zone rotary tube furnace.

If a discontinuously operating reactor has been used in step a), the cooling in step b) can also be carried out in the reactor itself, which is particularly simple to realize in engineering terms.

It would in principle also be possible to quench the reaction product obtained from step a) in water under a protective gas atmosphere. This makes rapid and simple cooling possible. However, a disadvantage in this case is that the reaction product is obtained as an aqueous suspension which firstly has to be worked up further, for example by means of solid/liquid separation and subsequent drying. This makes little sense from an energy point of view because the reaction product obtained from step a) is already dry and can be directly processed further in this stage. The cooled reaction product obtained after step b) can optionally be subjected to additional sieving and/or milling.

The Cr(VI) content of the cooled reaction product obtained after step b) is determined by the modified alkaline digestion process disclosed. A reduced oxidic solid is obtained after step b). Preference is given to obtaining a reduced oxidic solid which is characterized in that it contains a proportion of less than 15% by weight of calcium oxide, particularly preferably less than 10% by weight of calcium oxide, very particularly preferably less than 5% by weight of calcium oxide.

The reduced oxidic solid preferably contains less than 1000 ppm of Cr(VI), particularly preferably less than 100 ppm of Cr(VI), very particularly preferably less than 50 ppm of Cr(VD.

The invention is illustrated with the aid of the following examples without the invention being restricted thereby.

### EXAMPLES

### Determination of the Cr(VI) Content

Description of the test methods used:

Modified Alkaline Digestion Process

The determination of the Cr(VI) content of the oxidic solids used as starting materials and also the reaction products obtained was carried out by a method based on the alkaline digestion process described in USEPA SW-846 Method 3060A.

When the oxidic solid contains more than 2% by weight of water, it is dried to constant weight at 120° C. and then weighed out. However, in contrast to the process described in USEPA SW-846 Method 3060A, not from 2.4 g to 2.6 g of the sample to be examined are digested, but instead from 9.9 g to 10.1 g (balance accuracy 0.0001 g) of the oxidic solid are transferred quantitatively into a reaction flask having a protective gas connection. 50 ml of the alkaline digestion solution (produced by dissolving 20.0 g of NaOH (0.5 M) and 29.7 g of Na₂CO₃ (0.28 M) in 1.001 of demineralized water), 2 ml of a Mg(NO₃)₂ solution (prepared by dissolving 60.0 g of Mg(NO₃)₂*6 H₂O in 1001 of demineralized water) and 0.5 ml of a buffer solution having pH=7 are then added. The suspension is heated to boiling in a nitrogen atmosphere while stirring and heated under reflux for one hour, After one hour, the suspension is cooled to room temperature while stirring. The mixture is subsequently filtered in air and the filter cake is intensively washed with demineralized water. The mother liquor and washings obtained during filtration and washing are combined in a 500 ml standard flask, made up to the mark with demineralized water and analysed for Cr(VI) as described below. In contrast to the process described in USEPA SW-846 Method 3060A, a significantly larger amount of sample is thus used, but the alkaline extract is finally made up to 500 ml instead of 250 ml in the standard flask. Nevertheless, twice the Cr(VI) concentration in the standard solution used for the Cr(VI) determination by UV/VIS spectroscopy results from the above-described method, compared to the process described in USEPA SW-846 Method 3060A.

UV/Vis Spectroscopy for Determining the Chromium(VI) Content

A small amount of the clear solution is taken off from the standard flask containing the alkaline extract obtained from the alkaline digestion process and brought to a pH of 7 by means of dilute hydrochloric acid. This generally gives a precipitate of aluminium and silicon hydroxides, which is centrifuged off. The clear centrifugate obtained is filtered through a 0.45 μm syringe filter and its Cr(VI) content after setting of the pH is determined as 1,5-diphenylcarbazide complex by means of UV/Vis spectroscopy as described in USEPA Method 218.7. The measured Cr(VI) concentration is, if it can be quantified, back-calculated taking into account the dilution brought about by the setting of the pH with the dilute hydrochloric acid to the mass of the oxidic solid content originally used.

The determination of the Cr(VI) content was carried out at a wavelength of 539 nm on an automated UV/Vis spectrometer, model Metrohm 844 UV/VIS Compact IC. In this instrument, the monochromate is firstly separated off from other anions by means of an anion-exchange column before being reacted with 1,5-diphenylcarbazide in an after-column reactor and determined spectrophotometrically. In the case of the instrument used, the Cc(VI) determination limit is 0.0128 mg/l of Cr(VI). Taking into account 10 g of dried oxidic solid used for the above-described alkaline digestion process, this gives a determination limit of 0.64 mg of Cr(VI) per kg of oxidic solid, corresponding to 640 ppb of Cr(VI),

### Examples 1-7

The invention is described in more detail by the following examples without the invention being intended to be restricted thereby.

For the following examples, chrome ore residue from the industrial process for producing sodium monochromate from chromite via an oxidative alkaline digestion with sodium carbonate (known as no lime process, CaO content <5% by weight) was used. The chrome ore residue obtained in the form of a moist filter cake in the process for producing sodium monochromate after solid-liquid separation was merely dried but not sieved or milled.

General Procedure

Dried chrome ore residue whose Cr(VI) content had been determined by the above-described modified alkaline digestion process was heated in crucibles in an indirectly electrically heated horizontal tube furnace. The tube diameter was 70 mm and the total length was 1500mm, of which about 500 mm were heated. The crucibles were located in the heated region during the experiments.

The dried chrome ore residue was introduced into the cold furnace, both ends were closed in a gastight manner and nitrogen (>99.9990% by volume of nitrogen) was introduced from one end and at the opposite end was conveyed via an outlet opening and an immersed tube into the exhaust air. The furnace was heated to the desired target temperature under these conditions under a nitrogen gas stream (about 2 l/min at a furnace volume of about 6 1 l), maintained at this temperature for the desired time and then cooled again.

After cooling, the black reduced chrome ore residue reaction product was taken out and worked up by the above-described alkaline digestion process and the Cr(VI) content of the alkaline extract was determined by means of UV/Vis spectroscopy.

### Example 1

Dried chrome ore residue (Cr₂O₃: 8.7%, Al₂O₃:21.8%, Fe₂O₃: 46.5%, V₂O₅:0.04%, SiO₂: 1.3%, MgO: 13.3%, CaO: 0.04%, Na₂O: 2,9%, all figures in % by weight) having a content of 1409 ppm of Cr(VI) (corresponds to 0.43% by weight of Na₂CrO₄) was introduced into silicon carbide crucibles and heated at 900° C. under a nitrogen atmosphere as described in the general procedure for two hours and subsequently cooled to below 100° C. in a nitrogen atmosphere. The Cr(VI) content of the reaction product was found to be 31 ppm.

### Example 2

Dried chrome ore residue (Cr₂O₃: 9.2%, Al₂O₃: 19.8%, Fe₂O₅: 44.5%, V₂O₅: 0.04%, SiO₂: 1.4%, MgO: 14.6%, CaO: 0.04%, Na₂O: 2.5%, all figures in % by weight) having a content of 1474 ppm of Cr(VI) (corresponds to 0.45% by weight of Na₂CrO₄) was introduced into silicon carbide crucibles and heated at 900° C. under a nitrogen atmosphere as described in the general procedure for two hours and subsequently cooled to below 100° C. in a nitrogen atmosphere. The Cr(VI) content of the reaction product was found to be 40 ppm.

### Example 3

Dried chrome ore residue (Cr₂O₃: 9.2%, Al₂O₃: 19.8%, Fe₂O₃: 44.5%, V₂O₅: 0.04%, SiO₂:1.4%, MgO 14.6%, CaO: 0.04%, Na₂O: 2.5%, all figures in % by weight) having a content of 1474 ppm of Cr(VI) (corresponds to 0.45% by weight of Na₂CrO₄) was introduced into silicon carbide crucibles and heated at 1100° C. under a nitrogen atmosphere as described in the general procedure for four hours and subsequently cooled to below 100° C. in a nitrogen atmosphere. The Cr(VI) content of the reaction product was found to be <0.64 ppm.

### Example 4

Dried chrome ore residue (Cr₂O₃: 8.9%, Al₂O₃: 22.3%, Fe₂O₃: 43.8%, V₂O₅: 0.04%, SiO₂: 1.5%, MgO: 14.3%; CaO: 0.04%, Na₂O: 3.5%, all figures in % by weight) having a content of 7995 ppm of Cr(VI) (corresponds to 2.49% by weight of Na₂CrO₄) was introduced into silicon carbide crucibles and heated at 1100° C. under a nitrogen atmosphere as described in the general procedure for four hours and subsequently cooled to below 100° C. in a nitrogen atmosphere. The Cr(VI) content of the reaction product was found to be <0.64 ppm.

### Example 5

Dried chrome ore residue (Cr₂O₃: 8.9%, Al₂O₃: 22.3%, Fe₂O₃: 43.8%, V₂O₅: 0.04%, SiO₂: 1.5%, MgO: 14.3%, CaO: 0.04%, Na₂O: 3.5%, all figures % by weight) having a content of 7995 ppm of Cr(VI) (corresponds to 2.49% by weight of Na₂CrO₄) was introduced into silicon carbide crucibles and heated at 1000° C. under a nitrogen atmosphere as described in the general procedure for four hours and subsequently cooled to below 100°0 C. in a nitrogen atmosphere. The Cr(VI) content of the reaction product was found to be 27 ppm.

### Example 6

Dried chrome ore residue (Cr₂O₃: 8.9%, Al₂O₃: 22.3%, Fe₂O₃: 43.8%, V₂O₅: 0.04%, SiO₂: 1.5%, MgO: 14.3%, CaO: 0.04%, Na₂O: 3.5%, all figures in % by weight) having a content of 7995 ppm of Cr(VI) (corresponds to 2.49% by weight of Na₂CrO₄) was introduced into silicon carbide crucibles and heated at 1100° C. under a nitrogen atmosphere as described in the general procedure for two hours and subsequently cooled to below 100° C. in a nitrogen atmosphere. The Cr(VI) content of the reaction product was found to be <0.64 ppm.

### Example 7

Dried chrome ore residue (Cr₂O₃: 8.3%, Al₂O₃: 22.01%, Fe₂O₃: 45.7%, V₂O₃: 0.07%, SiO₂: 1.4%, MgO: 10.4%, CuO: 0.06%, Na₂O: 3.4%, all figures in % by weight) having a content of 5714 ppm of Cr(VI) (corresponds to 1.8% by weight of Na₂CrO₄) was introduced into silicon carbide crucibles and heated at 1000° C. in a vacuum of 400 mbar as described above departing from the general procedure for two hours and subsequently cooled to below 100° C. under the same vacuum. The Cr(VI) content of the reaction product was found to be <0.64 ppm.

1. A process for reducing hexavalent chromium in oxidic solids, the process comprising:
a) heating an oxidic solid containing Cr(VI) to a temperature of 600 to 1400° C. in an atmosphere containing less than 0.1% by volume of an oxidizing gas to produce a reaction product; and
b) cooling the reaction product to a temperature below 100° C. in an atmosphere containing less than 0.1% by volume of an oxidizing gas to produce a resultant product:
wherein no reducing agent is added to the oxidic solid or to the atmosphere in steps a) and b) in the process.

2. The process according to claim 1, wherein the oxidic solid a chrome ore residue.

3. The process according to claim 1, wherein the oxidic solid comprises up to 80,000 ppm of Cr(VI).

4. The process according to claim 1, wherein the Cr(VI) in the oxidic solid is present as sodium monochromate (Na₂CrO₄).

5. The process according to claim 1, wherein the oxidic solid comprises:
chromium(III) oxide (Cr₂O₃): from 7 to 13% by weight, preferably from 7.5 to 12.5% by weight
aluminium oxide (Al₂O₃): from 10 to 30% by weight, preferably from 18 to 24% by weight
iron(III) oxide (Fe₂O₃): from 42 to 50% by weight, preferably from 42 to 48% by weight
magnesium oxide (MgO): from 9 to 18% by weight, preferably from 10to 17% by weight
calcium oxide (CaO): <10% by weight, preferably <5% by weight silicon oxide (SiO₂): from 0 to 3% by weight, preferably from 1to 3% by weight vanadium oxide (V₂O₅): <1% by weight, preferably <0.5% by weight sodium oxide (Na₂O): from 0 to 5% by weight, preferably from 2 to 5% by weight; and
sodium monochromate (Na₂CrO₄); from 0.3 to 4.7% by weight.

6. The process according to claim 1, wherein at least 90% of the particles of the oxidic solid are smaller than 500 μm, particularly preferably smaller than 300 μm.

7. The process according to claim 1, wherein the atmosphere in step a) is selected from the group consisting of an inert gas atmosphere and a vacuum.

8. The process according to claim 7, wherein the atmosphere in step a) is an inert gas atmosphere and comprises at least 90% by volume of one or more gases selected from the noble gas.

9. The process according to claim 7, wherein the atmosphere in step a) is an atmosphere having a pressure of less than 800 mbar.

10. The process according to claim 1, wherein the oxidic solid in step a) is heated to a temperature of 850° C. to 1200° C.

11. The process according to claim 1, wherein the heating in step a) is carried out in a continuously operating or discontinuously operating reactor.

12. The process according to claim 11, wherein the reactor is a reactor which is indirectly heated by means of gas or electricity.

13. The process according to claim 11, wherein the reactor is an indirectly electrically heated horizontal tube furnace,

14. The process according to claim 1, wherein the reaction product is cooled to a temperature below 40° C.

15. The process according to claim 1, wherein the heating in step a) and the cooling in step b) are done in the same reactor, wherein, after producing the reaction product in the reactor in step a), indirect heating of the reactor is switched off, the reaction product is left in the reactor for step b), and the reactor is subsequently cooled by introducing inert gas into the reactor.

16. The process according to claim 1, wherein the oxidic solid comprises 1000 to 15,000 ppm of Cr(VI), and the resultant product has a a Cr(VI) content of <1000 ppm.

17. The process according to claim 16, wherein:
the atmosphere in step a) contains less than 0.1% by volume of an oxidizing gas, and is at least one of an inert gas atmosphere and a vacuum;
the oxidic solid in step a) is heated to a temperature of 850° C. to 1200° C.;
the oxidic solid is a particulate chrome ore residue wherein at least 90% of the particles of the oxidic solid are smaller than 300 μm;
the Cr(VI) in the chrome ore residue is present as sodium monochromate (Na₂CrO₄);
the chrome ore residue comprises 0.3 to 4.7% by weight sodium monochromate (Na₂CrO₄); and
the atmosphere in step b) is an inert gas atmosphere, wherein inert gas is introduced in step b) to cool the reaction product to a temperature below 40° C.,

18. The process according to claim 17, wherein:
steps a) and b) are performed consecutively in the same reactor; and
the atmosphere in step a) contains less than 0.01% by volume of oxygen, and is at least one of an inert gas atmosphere and a vacuum, wherein:
the inert gas atmosphere comprises at least 95% by volume of one or more gases selected from helium, argon, nitrogen and carbon dioxide; and
the vacuum atmosphere is at a pressure of less than 650 mbar.

19. The process according to claim 16, wherein:
the oxidic solid in step a) is heated to a temperature of 950° C. to 1150° C.;
the reaction product in step b) is cooled to a temperature below 30° C.;
the reactor is configured for continuous operation and is an indirectly, electrically heated, rotary tube furnace, oriented horizontally and having two-zones;
the inert gas atmosphere comprises at least 99.9% by volume of one or more of nitrogen and carbon dioxide;
the vacuum atmosphere is at a pressure of less than 450 mbar;
the chrome ore residue is a residue obtained in the oxidative alkaline digestion of chrome ores for the production of sodium monochromate, and additionally comprises:
7.5 to 12.5% by weight chromium(III) oxide (Cr₂O₃);
18 to 24% by weight aluminium oxide (Al₂O₃);
42 to 48% by weight iron(III) oxide (Fe₂O₃);
10 to 17% by weight magnesium oxide (MgO);
<5% by weight calcium oxide (CaO);
1 to 3% by weight silicon oxide (SiO₂);
<0.5% by weight vanadium oxide (V₂O₅); and
2 to 5% by weight sodium oxide (Na₂O).

20. A process for reducing hexavalent chromium in chrome ore residues, wherein the chrome ore residues contain hexavalent chromium Cr(VI) in the form of sodium monochromate (Na₂CrO₄), the process comprising:
a) heating the chrome ore residue to a temperature of 850° C. to 1200° C. in an atmosphere containing less than 0.1% by volume of an oxidizing gas to produce a reaction product; and
b) cooling the reaction product to a temperature below 40° C. in an atmosphere containing less than 0.1% by volume of an oxidizing gas to provide a product having a Cr(VI) content of <1000 ppm,
wherein steps a) and b) are performed consecutively in the same reactor, and no reducing agent is added to the ore residue or to the atmosphere in steps a) and b).
